(19) United States
(12) Patent Application Publication
(10) Pub. No.: US 2025/0249665 A1
(43) Pub. Date: Aug. 7, 2025

(54) SHEATHING PANEL WITH INTEGRATED GRID OVERLAY

(71) Applicant: LOUISIANA-PACIFIC CORPORATION, NASHVILLE, TN (US)

(72) Inventor: NEIL FREIDBERG, LEBANON, TN (US)

(21) Appl. No.: 19/044,161

(22) Filed: Feb. 3, 2025

Related U.S. Application Data
(60) Provisional application No. 63/627,861, filed on Feb. 1, 2024.

(51) Int. Cl. B32B 21/04; B32B 3/12; B32B 15/02; B32B 15/10; B32B 15/12; B32B 15/18; B32B 21/02; B32B 21/08; B32B 27/10; B32B 37/10

(52) U.S. Cl. CPC B32B 21/042; B32B 3/12; B32B 15/02; B32B 15/10; B32B 15/12; B32B 15/18; B32B 21/02; B32B 21/08; B32B 27/10; B32B 37/10; E04B 1/62; B32B 2260/028; B32B 2260/046; B32B 2305/38; B32B 2307/514; B32B 2307/518; B32B 2307/712; B32B 2311/30; B32B 2317/125; B32B 2317/16; B32B 2398/20; B32B 2607/00

(57) ABSTRACT

A sheathing panel with an integrated weather-resistant membrane or layer, with a grid overlay. The grid is made of material able to maintain its structure and integrity while being subjected to the pressing process described herein. The grid may be integrated into the WRB membrane itself during the WRB membrane manufacturing process. In the alternative, the grid may separately added during the panel manufacturing process, with the grid being placed underneath or on top of the WRB membrane.

This application claims benefit of and priority to U.S. Provisional Application No. 63/627,861, filed Feb. 1, 2024, which is incorporated herein in its entirety by specific reference for all purposes.

### FIELD OF INVENTION

This invention relates to weather resistive barrier sheathing panels with an integrated grid overlay.

### BACKGROUND OF INVENTION

Wall and roof sheathing panels may consist of, but are not limited to, plywood, oriented-strand board (OSB), paper board, foam, gypsum, and glass mat. Sheathing panels typically are produced sizes of 4′×8′, 4′×9′, 4′×10′ or similar dimensions. Wall sheathing is typically installed on the outside of a building's exterior envelope and may or may not be In general, wood-based composites include, but are not limited to, oriented strand board (OSB), wafer board, flake board, particleboard, and fiberboard (e.g., medium density fiberboard, or MDF). These wood-based composites are typically formed from a wood element (e.g., flake, strand, particle, wafer) combined with a thermosetting adhesive to bind the wood substrate together. In some processes, other additives are added to impart additional properties to the wood composites. Additives may include fire retardants, fungicides, mildewcides, insecticides, and water repellents. A significant advantage of strand and particle-based wood composites is that they have many of the properties of plywood and dimensional lumber, but can be made from a variety of lower grade wood species, smaller trees and waste from other wood product processing. In addition, they can be formed into panels in lengths and widths independent of the size of the harvested timber.

One class of wood-based composites products comprise multilayer, oriented wood strand panel products. These oriented-strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on a mat-forming line with the strands of the outer face layers predominantly oriented in a parallel-to-machine direction, and strands in the core layer generally oriented perpendicular to the face layers (i.e., “cross-machine”) direction.

In one known commercial process, these mat layers are bonded together using natural or synthetic adhesive resins under heat and pressure to make the finished product. Oriented, multilayer wood strand panels of the above-described type can be produced with mechanical and physical properties comparable to those of commercial softwood plywood and are used interchangeably, such as for wall and roof sheathing. In certain types of construction, these wood-based panels (and other construction materials) may be required by building codes to meet certain durability requirements, such as fire, wind and water resistance.

Oriented, multilayer wood strand panels and similar products of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes. structural in design.

Building codes typically require that a weather resistive barrier layer be applied to this sheathing layer prior to installation of exterior cladding. Weather resistive barriers have traditionally been applied on the jobsite following the installation of the wall sheathing. The weather resistive barrier membrane is typically sold in long rolls and fastened to the sheathing panels. The membrane will span multiple adjacent sheathing panels and is installed in a manner as to provide top over bottom and side overlaps to allow water to run from one layer to the next without entrapment (shingling). The membrane, once installed, is often left vulnerable to wind and weather which may cause damage to the membrane. Field-installed membranes also are difficult to properly air seal to meet building exterior air barrier requirements.

To address some of the problems of field-applied membranes, a new generation of products have been developed which have the weather resistive barrier or membrane factory-applied to the wall sheathing, which are then fastened as an integrated product to the wall framing in a similar manner to the sheathing products listed above. In the case of a manufactured wood panel, the manufactured wood strand mat and the weather resistive barrier, typically a resin-impregnated paper overlay, are subjected to heat and/or pressure in a press at the same time to form an integrated panel with WRB. This process can lead to hard-to-detect defects in the WRB membrane, often resulting from the texture of the surface of the OSB and the WRB membrane.

### SUMMARY OF INVENTION

In various exemplary embodiments, the present invention comprises a sheathing panel with an integrated WRB membrane with an additional grid overlay. The grid may be added during the manufacturing process to the sheathing panel with an integrated WRB membrane. The grid is made of material able to maintain its structure and integrity while being subjected to the pressing process described herein. The grid comprises a plurality of one or more polygonal shapes, such as, but not limited to, square, rectangles, pentagons, hexagons, and the like, or combinations thereof. The grid overlay may comprise material forming the perimeter edges of the squares or other polygonal shapes, with open space inbetween. In some alternative embodiments, the space between may comprise a layer of material extending, in whole or in part, between the perimeter edges, where in the layer is thinner than the thickness of the grid perimeter edges.

The grid may be integrated into the WRB membrane itself during the WRB membrane manufacturing process, so that the integrated WRB membrane with grid is then used in the panel manufacturing process described above. Thus, for example, the integrated WRB membrane with grid may be placed on the upper surface of the strand mat prior to insertion into the press.

In alternative embodiments, the grid may separately added during the panel manufacturing process. Thus, for example, the grid may be placed underneath or on top of the WRB membrane, with both sitting on the top of the strand mat, prior to insertion into the press.

The grid may be placed on the strand mat or WRB membrane at several points in the manufacturing process. In some embodiments, the WRB membrane and grid (whether previously integrated or separate) may be added to a previously-manufactured panel in a secondary process, which may be a second pressing process.

### BRIEF DESCRIPTION OF THE DRAWINGS

FIG. 1 shows a view of a panel with grid overlay in accordance with an exemplary embodiment of the present invention.

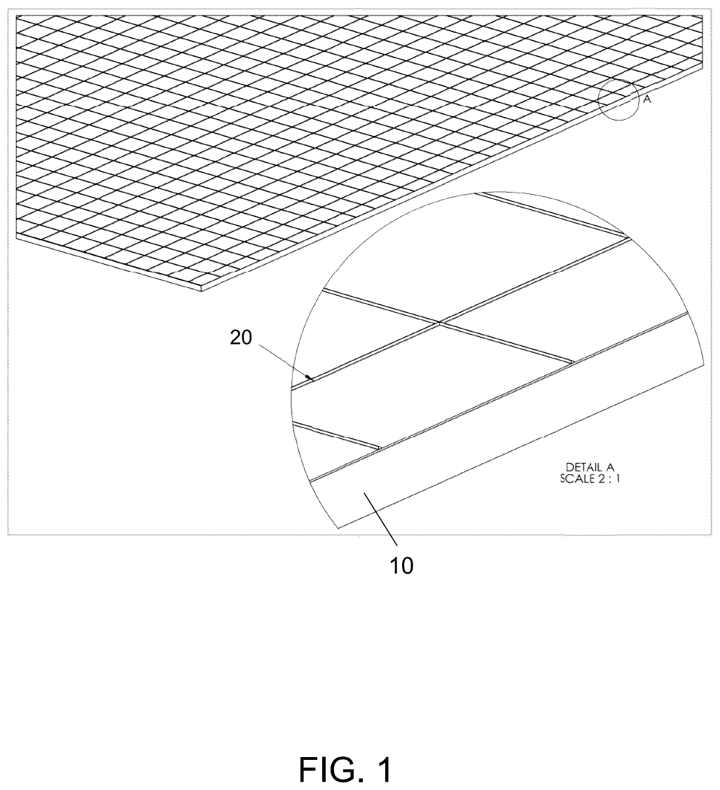

FIG. 2 shows a cutaway side view of a structural panel with a grid interposed between the base OSB panel and the WRB membrane.

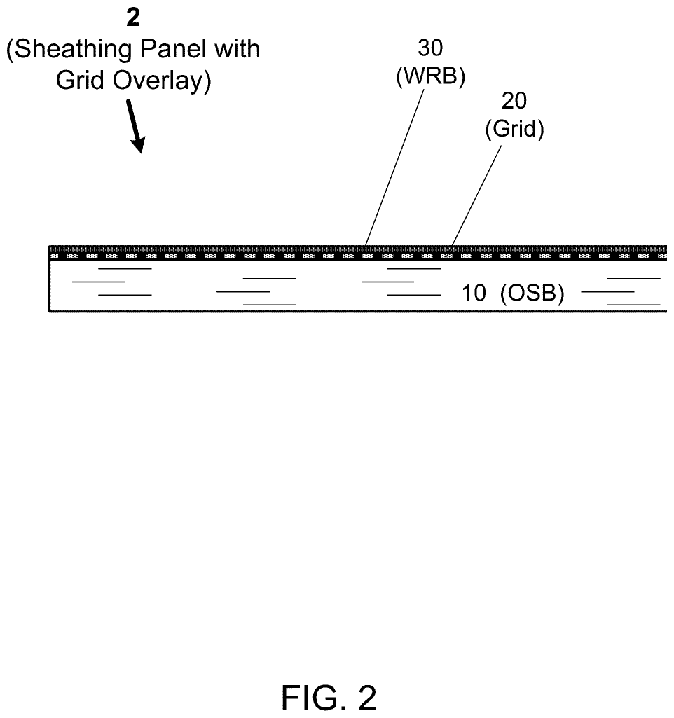

FIG. 3 shows a cutaway side view of a structural panel with a grid affixed to the upper surface of the WRB.

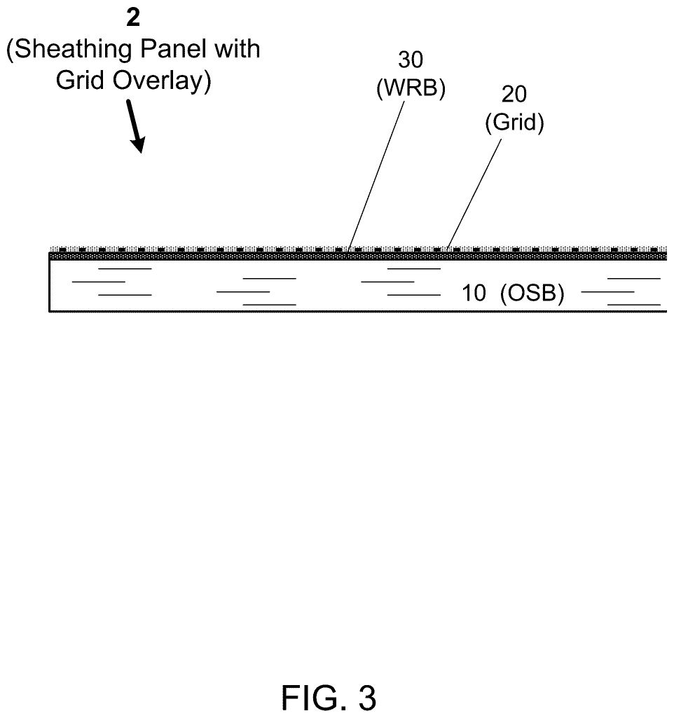

FIG. 4 shows an exploded side view of the order of construction for a structural panel with a grid and WRB added to a OSB panel post-press.

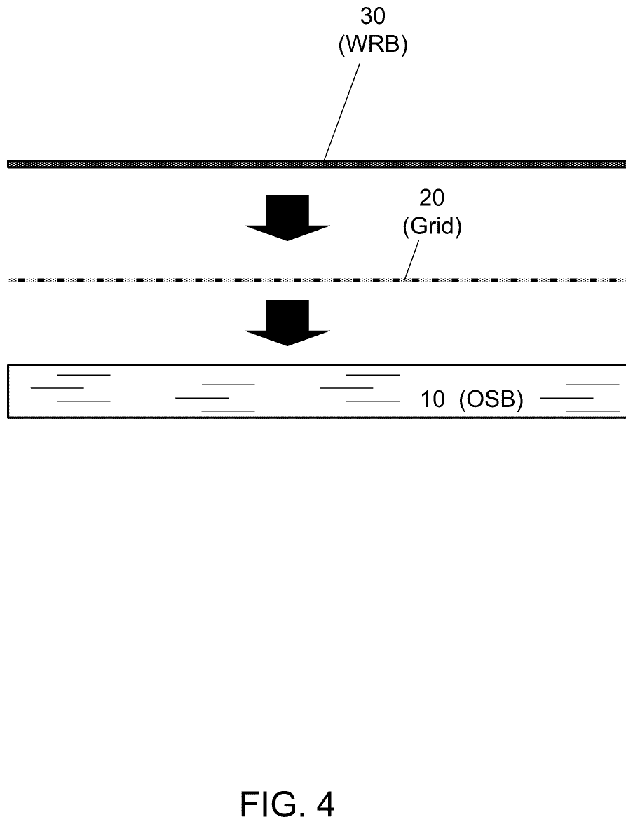

FIG. 5 shows an exploded side view of the order of construction for a structural panel with an integrated grid and WRB added to a OSB panel post-press.

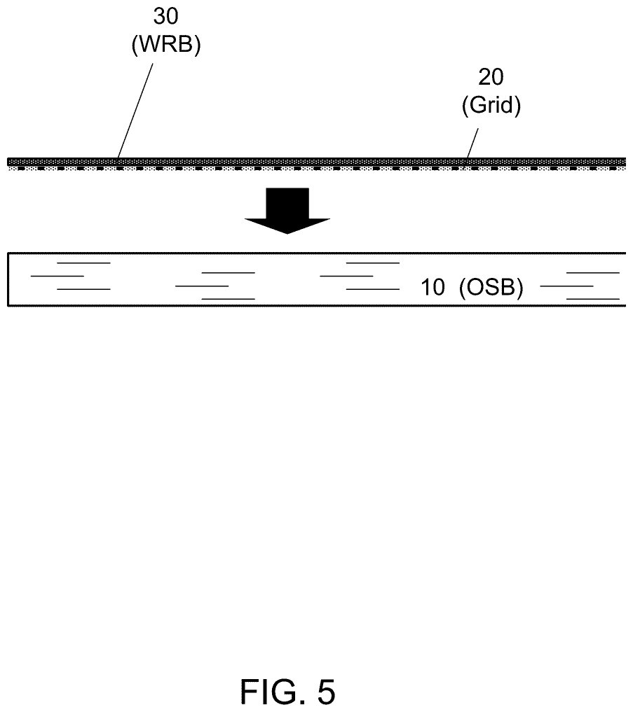

FIG. 6 shows an exploded side view of the order of construction for a structural panel with a grid and WRB added to a strand mat pre-press.

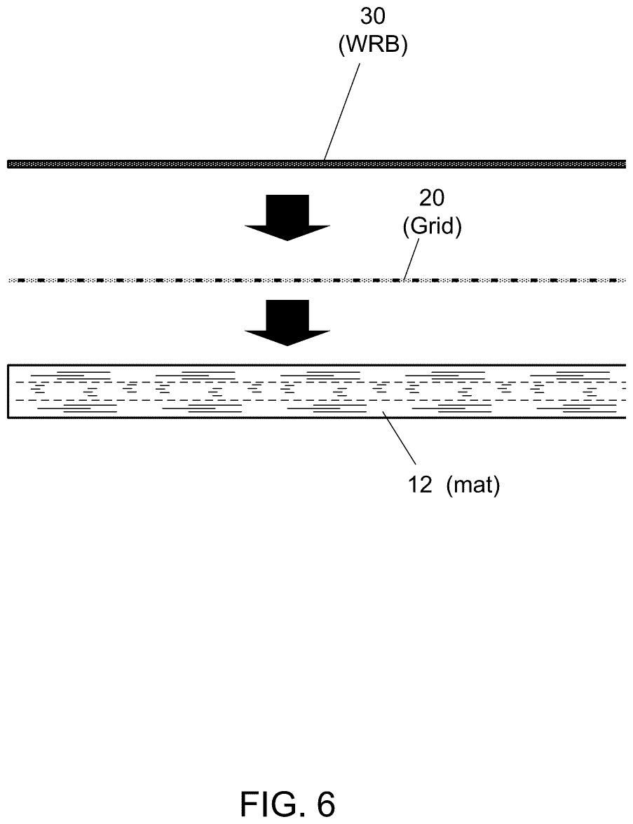

FIG. 7 shows an exploded side view of the order of construction for a structural panel with an integrated grid and WRB added to a strand mat pre-press.

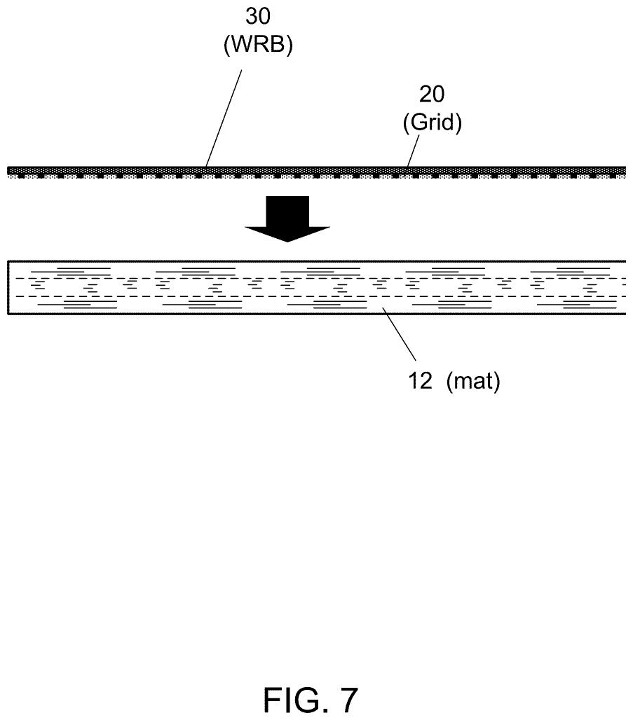

FIG. 8 is a diagram of a method of producing a structural panel with a grid and WRB added to a strand mat on a production line pre-press.

FIG. 9 is a diagram of a method of producing a structural panel with a WRB overlay with integrated grid added to a strand mat on a production line pre-press.

FIG. 10 is a diagram of a method of producing a structural panel with a WRB overlay with a grid and WRB added to an OSB panel post-press.

FIG. 11 is a diagram of a method of producing a structural panel with a WRB overlay with integrated grid added to an OSB panel post-press.

FIG. 12 is a diagram of producing a structural panel with a WRB overlay added to a strand mat on a production line pre-press, with the grid laminated or adhered to the upper surface of the OSB with WRB boards post-press.

FIG. 13 is a diagram showing a variation of the method of FIG. 12, where the grid is laminated or adhered to the upper surface of the OSB with WRB blanks or panels after the boards have been trimmed post-press.

### DETAILED DESCRIPTION OF EXEMPLARY EMBODIMENTS

In various exemplary embodiments, the present invention comprises a multi-layer sheathing panel 2 with a base panel substrate 10 with an integrated WRB membrane 30 with an additional grid overlay 20. The grid 20 may underlay or overlay the WRB layer 30. The grid 20 may be added during the manufacturing process of the base panel substrate and integration with the WRB membrane (i.e., pre-press), or added post-press as a secondary process, either separate from the WRB membrane or integrated with it. The grid 20 may extend over the entirety of the panel or WRB surface, or only a portion thereon. In one embodiment, the grid may only extend on the surface along the edges for a certain distance inward (e.g., 2″, 3″, 4″, 6″, 12″, and the like). However, the advantage of a grid extending over the entirety of the surface is that it allows the user in the field to cut pieces or sections from the panel for installation in the field while still providing a grid pattern along all edges of the panel piece or section after cutting.

The grid 20 is made of material able to maintain its structure and integrity while being subjected to the pressing process described herein (i.e., not melting or deforming under pressure and press operating temperatures), such as metal, steel, aluminum, heat-resistant plastic, plastic filaments, carbon fiber strands of filaments, or the like. The grid comprises a plurality of one or more polygonal shapes, such as, but not limited to, square, rectangles, pentagons, hexagons, and the like, or combinations thereof. The grid overlay may comprise material forming the perimeter edges of the squares or other polygonal shapes, with open space inbetween. In some alternative embodiments, the space between may comprise a layer of material (the same or different from the material from which the grid is made) extending, in whole or in part, between the perimeter edges of the polygonal shape, wherein the thickness of this in-between layer is thinner than the thickness of the grid perimeter edges.

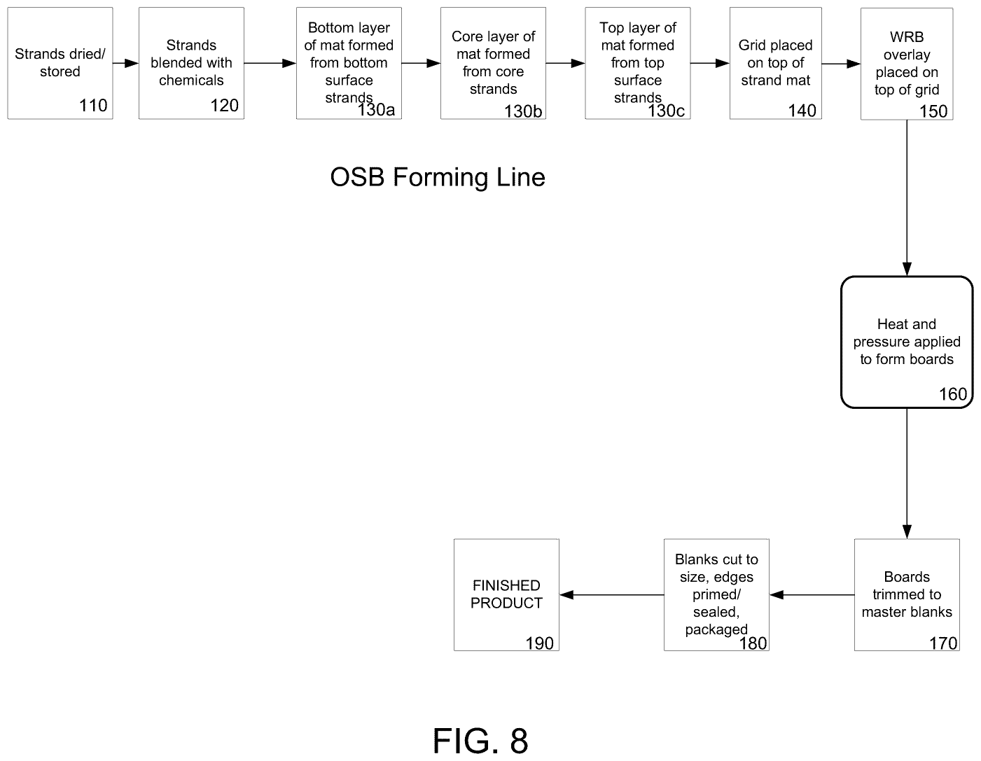

FIGS. 8-13 shows the steps of various embodiments of methods to produce the corresponding embodiments of the structural panel. Strands are produced from debarked logs and dried and stored 110. The strands are then blended with resins, adhesives, and other chemicals 120. The treated strands are then used to form multiple layers on an OSB forming line: e.g., bottom layer 130a, core layer 130b, top layer 130c. The number of layers in the mat may vary beyond the three shown. After the mat is formed (which may include an optional fines layer on the mat upper surface), the grid overlay is applied 140, followed by the WRB overlay 150, and the mat and grid and WRB overlays are subjected to heat and pressure to form boards 160, which then are trimmed to “blanks” 180. The blank are trimmed or cut to the desired size, primed/sealed, and/or packaged 170 to produce the finished product 190.

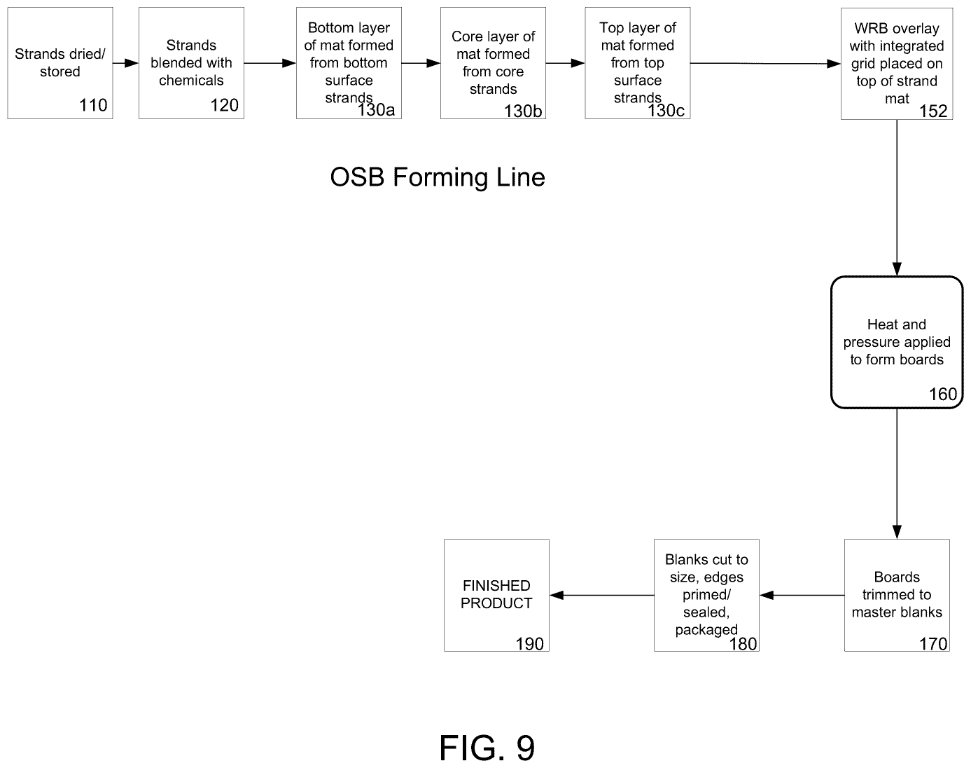

As seen in FIG. 9, the grid may be integrated into the WRB membrane itself during the WRB membrane manufacturing process, so that the integrated WRB membrane with grid is then used in the panel manufacturing process described above. Thus, for example, the integrated WRB membrane with grid may be placed on the upper surface of the strand mat 152 prior to insertion into the press.

In alternative embodiments, the grid 20 may separately added during the panel manufacturing process, as seen in FIG. 8. Thus, for example, the grid 20 may be placed underneath or on top of the WRB membrane 30, with both sitting on the top of the strand mat 12, prior to insertion into the press.

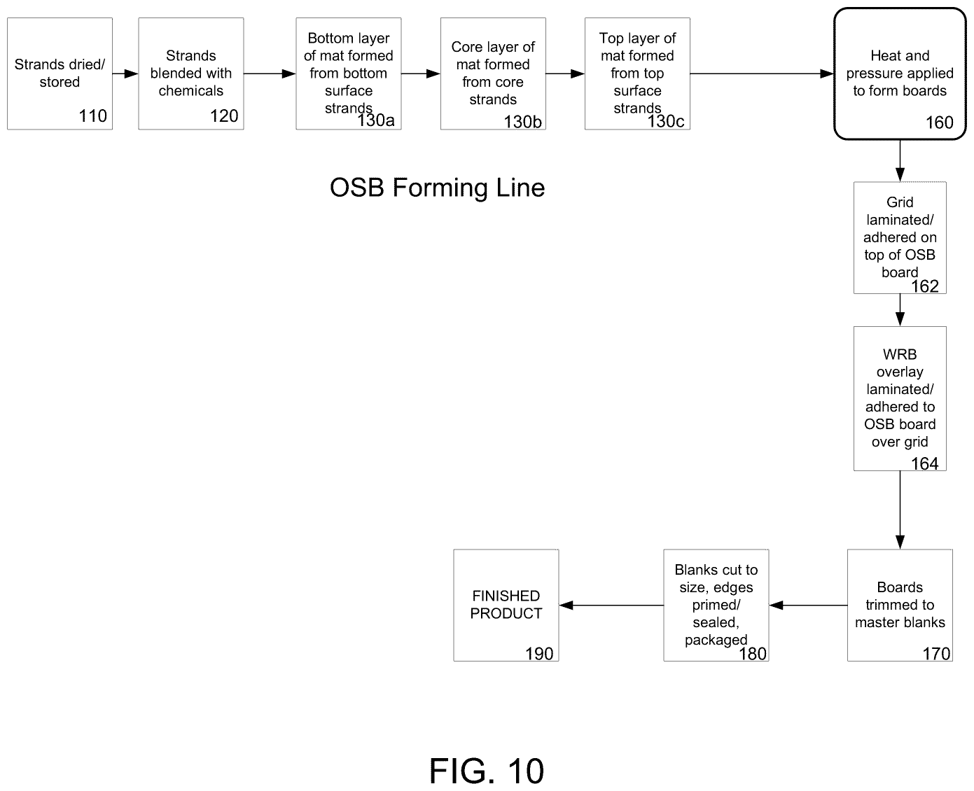

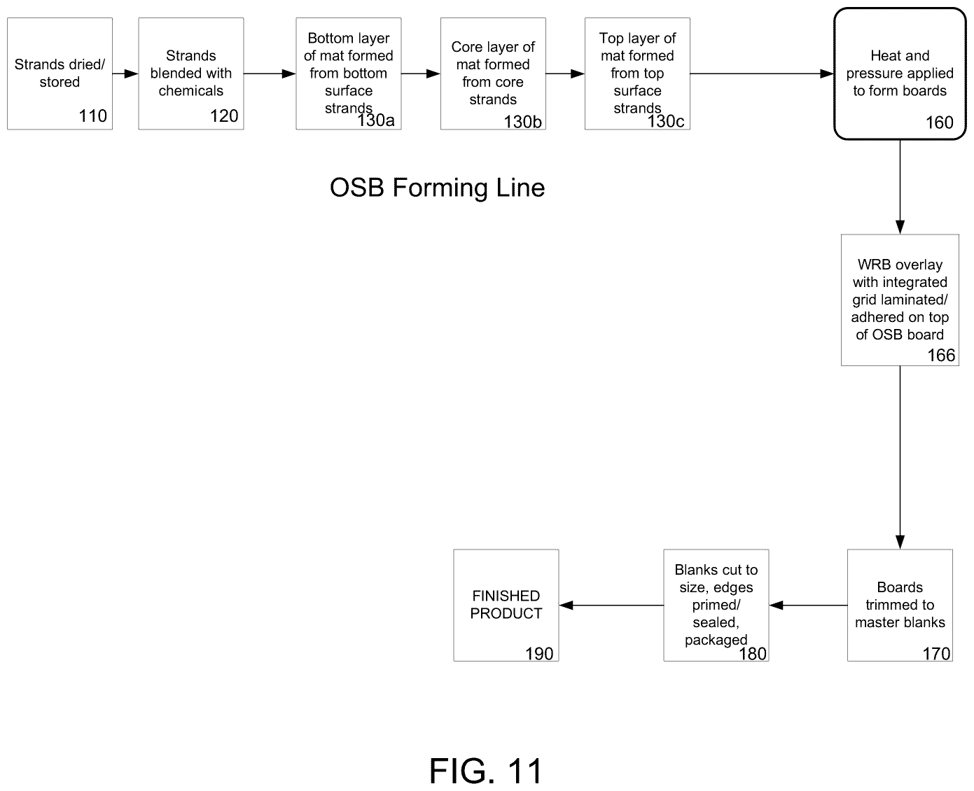

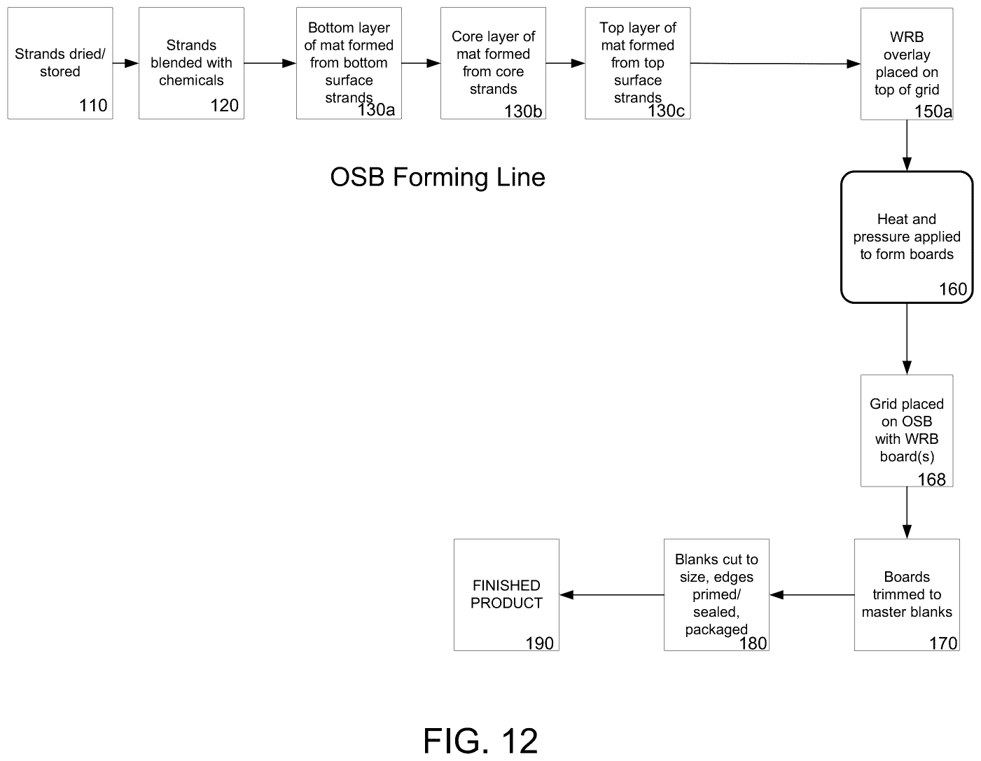

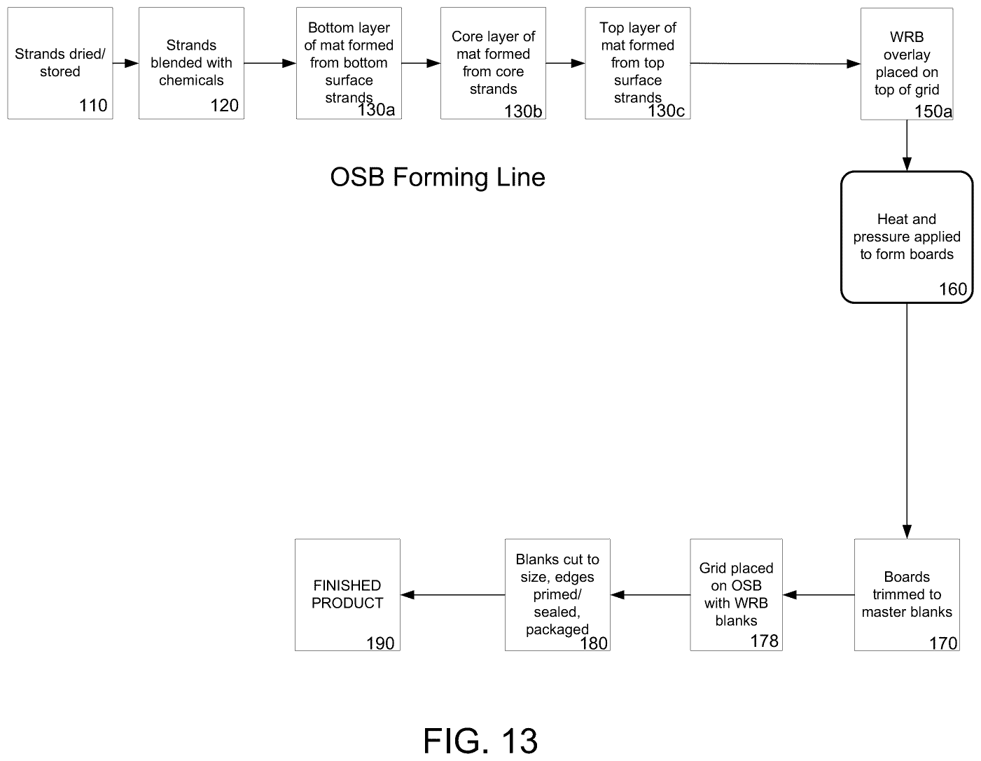

The grid also may be placed on the strand mat or under or on the WRB membrane at several points in the manufacturing process. In some embodiments, the WRB membrane 30 and grid 20 (whether previously integrated or separate) may be added to a previously-manufactured OSB panel substrate 10 in a secondary process, which may be a second pressing process, or a lamination or adhesion process (steps 162, 164 in FIG. 10, or step step 166 in FIG. 11). As seen in FIG. 12-13, the WRB membrane also may be added pre-press 150a, and the grid then added in a post-press process, either as a single grid applied to the board 168, or later, after the boards have been trimmed to master blanks or panels 178.

When placed under or integrated with the WRB membrane, the grid causes and supports a corresponding raised grid pattern on the surface of the WRB membrane. When placed over the WRB membrane, the grid forms the raised grid pattern itself.

The grid provides several advantages over the prior art. The presence of the grid reduces and/or eliminates the above-described defects in the WRB membrane produced during the prior art process. The grid also may increase surface friction by adding a texture on the outer surface of the WRB, reducing the potential for slipping by an installer or user, particularly in roofing installations where the installer or user may walk on the outer surface of the panel. The grid produces the surface texture not by embossing or similar means, but by underlying the WRB and telegraphing the pattern through the WRB layer without tearing, ripping or otherwise causing holes or penetrations in the WRB layer. In certain alternative embodiments, the grid layer can be adhered or laminated to the outer surface and thus directly provide the texture.

The grid texture also enhances the application of seam tape to seal joints between adjacent panels, making water intrusion under the tape more difficult. In order to complete the system as a weather resistive barrier, the panel joints, both the short (typically 4′) and long (typically 8′, 9′, or 10′) must be sealed. The most common sealing method used currently consists of heavy flashing tapes that are applied so that the center of the tape width aligns with the center of the panel joint and therefore covers all nails used to fasten the sheathing along the panel edges. Proper installation of the tape and/or fluid applied sealing systems is a critical step in the weather resistive barrier assembly, and time and care must be taken to ensure a durable, long lasting, sealed joint. As panel joints are lengthy it is often challenging for installers to ensure tape alignment and any corrections made during installation will typically result in a small fold in the tape which compromises the system. Proper adhesion of the tape or fluid sealant to the sheathing is another critical performance element and is often impacted negatively by dirt and moisture on the jobsite along with variable temperature and humidity. Many tapes used also require adequate pressure to bond the adhesives (pressure sensitive tapes), which can be challenging for installers that are often working above ground with limited mobility. The integrated grid helps address these installation and product issues.

In one exemplary embodiment, the grid forms 0.25″ to 4″ squares, more preferably 1.0″ to 2.0″ squares, most preferably 1.5 to 2.5″ squares or 2″ squares. This area allows nails or other fasteners to penetrate through with the head securely seated against the underlying upper surface of the panel (between the raised portions of the grid). It also provides a textured surface for a flashing tape to grip.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A multilayer panel with an integrated grid overlay, comprising:
a panel substrate of manufactured wood, with a top surface and a bottom surface;
an integrated weather-resistant membrane or layer, affixed to the top surface; and
a grid overlay comprising a pattern of one or more polygonal shapes;
wherein the grid overlay pattern is configured to create a corresponding grid pattern on an outer surface of the multilayer panel.

2. The multilayer panel of claim 1, wherein the panel substrate is oriented strand board.

3. The multilayer panel of claim 2, wherein the panel substrate comprises three strand layers, with a core layer with strands oriented perpendicular to the strands in a surface layer.

4. The multilayer panel of claim 1, wherein the grid overlay comprises steel or metal.

5. The multilayer panel of claim 1, wherein the grid overlay comprises plastic.

6. The multilayer panel of claim 1, wherein the weather-resistant membrane or layer comprises a resin-impregnated paper overlay.

7. The multilayer panel of claim 1, wherein the grid overlay is positioned between the top surface of the panel substrate and the weather-resistant membrane or layer.

8. The multilayer panel of claim 1, wherein the one or more polygonal shapes comprises a square or rectangle.

9. The multilayer panel of claim 1, wherein the weather-resistant membrane layer and the grid overlay are an integrated WRB-grid layer.

10. A method of producing the multilayer panel of claim 1, comprising the steps of:
forming a base layer of strands on a forming line;
forming a core layer of strands on the base layer;
forming a top layer of strands on the core layer;
placing the grid overlay on the top layer of strands;
placing the weather-resistant membrane or layer on the grid overlay; and
subjecting the strand layer, grid overlay, and weather-resistant membrane or layer to heat and pressure.

11. A method of producing the multilayer panel of claim 1, comprising the steps of:
forming an integrated WRB-grid layer from the weather-resistant membrane layer and the grid overlay;
forming a base layer of strands on a forming line;
forming a core layer of strands on the base layer;
forming a top layer of strands on the core layer;
placing the integrated WRB-grid layer on the top layer of strands; and
subjecting the strand layer and integrated WRB-grid layer to heat and pressure.
